(19) United States
(12) Patent Application Publication
(10) Pub. No.: US 2022/0018505 A1
(43) Pub. Date: Jan. 20, 2022

(54) LUMINAIRE STRUCTURES

(71) Applicant: AXIS LIGHTING INC., Lasalle (CA)

(72) Inventors: Steven LAVICTOIRE, Lasalle (CA); Andrew MILES, Lasalle (CA); Howard YAPHE, Lasalle (CA)

(21) Appl. No.: 17/490,048

(22) Filed: Sep. 30, 2021

Related U.S. Application Data
(63) Continuation-in-part of application No. 29/652,788, filed on Nov. 30, 2020.
Application No. 29/652,788 is a continuation of application No. 16/381,801, filed on Apr. 11, 2019, now Pat. No. 10,871,263.
Application No. 16/381,801 is a continuation of application No. 15/189,199, filed on Jun. 22, 2016, now Pat. No. 10,288,238.
Application No. 15/189,199 is a continuation-in-part of application No. 14/747,645, filed on Jun. 23, 2015, now Pat. No. 9,416,535.
Application No. 16/381,801 is a continuation-in-part of application No. 29/568,080, filed on Jun. 15, 2016, now Pat. No. D859719.
Application No. 29/568,080 is a continuation-in-part of application No. 14/747,645, filed on Jun. 23, 2015, now Pat. No. 9,416,535.

(30) Foreign Application Priority Data
Dec. 18, 2015 (CA) 166060

(51) Int. Cl. F21S 8/02; F21V 7/05; E04B 9/00; F21V 3/04; F21V 21/04

(52) U.S. Cl. CPC F21S 8/026; F21V 7/05; F21Y 2115/10; F21V 3/04; F21V 21/048; E04B 9/006

(57) ABSTRACT

A luminaire module includes a support structure configured for an overhead or region of a defined space suitable to support the luminaire module. The support structure may support a plurality of panels with each defining an illuminatable presentation surface, the plurality including at least one first panel including a first peripheral region. The first panel may be inclined at a first angle of less than 90 degrees from a first reference plane, and one or more second panels, each of which being oriented to be upright at a second angle of less than 90 degrees from a second reference plane. The luminaire module may be configured to be assembled in an array with the presentation surfaces in the array providing a composite image in three dimensions formed by a plurality of image segments provided by the presentation surfaces of the modules in the array.

### REFERENCE TO CO-PENDING APPLICATION

This application is a Continuation-in-Part of U.S. Design application 29/652,788, filed Nov. 30, 2020, which is a which is a continuation of U.S. application Ser. No. 16/381,801, filed Apr. 11, 2019 (now U.S. Pat. No. 10,871,263), which is a continuation of U.S. application Ser. No. 15/189,199, filed Jun. 22, 2016 (now U.S. Pat. No. 10,288,238), which is a continuation-in-part of U.S. application Ser. No. 14/747,645, filed Jun. 23, 2015 (now U.S. Pat. No. 9,416,535) and said U.S. application Ser. No. 16/381,801 is a continuation in part of U.S. application Ser. No. 29/568,080 filed Jun. 15, 2016 (now U.S. Design Pat. D859719), which claims priority on Canadian Industrial Design application 166060 filed Dec. 18, 2015, and which is a continuation-in-part of U.S. application Ser. No. 14/747,645 filed Jun. 23, 2015 (now U.S. Pat. No. 9,416,535). The disclosures set forth in the referenced applications are incorporated herein by reference in their entireties

### FIELD OF THE DISCLOSURE

The present disclosure relates to luminaire structures and other ceiling or surface mountable structures.

### BACKGROUND

Generally, the lighting of an interior space involves ceiling-mounting lighting, such as with pendant, surface mounted or recessed configurations. In some cases, the lighting provides a planar presentation of an image, as provided either by a planar static image on a printed lens, or a screen such as an LCD computer screen (or television), the latter being common in such places as a dental office where a patient can view the screen in a reclined position.

### SUMMARY

In an aspect, there is provided a luminaire module comprising a support structure configured to be positioned so as to be associated with an overhead or ceiling region of a defined space suitable to support the luminaire module. The support structure may include or support a plurality of panels with each thereof defining a illuminatable presentation surface, the plurality including at least one first panel including a first peripheral region. The first panel may be configured to be inclined at a first angle of less than 90 degrees from a first reference plane, and a plurality of second panels, each of which being oriented to be upright at a second angle of less than 90 degrees from a second reference plane, in which the second panels are in side by side relation along the first peripheral region. The luminaire module may be configured to be assembled in an array thereof. The array may include modules of different geometries, dimensions, and vertical plane extensions to provide a composite presented image in three dimensions formed by a plurality of image segments provided by the presentation surfaces of the modules in the array.

In another aspect, there is provided a luminaire module comprising a support structure configured to be positioned so as to be associated with a ceiling region of an interior space. The support structure may include or support a plurality of panels with each thereof defining an illuminatable presentation surface. The plurality may include at least one first panel including a first peripheral region. The first panel may be configured to be inclined at a first angle of less than 90 degrees from a first reference plane. A plurality of second panels may also be provided, each of which being oriented to be upright at a second angle of less than 90 degrees from a second reference plane, in which the second panels are in side by side relation along the first peripheral region, wherein the luminaire module is configured to be assembled in an array thereof with the presentation surfaces in the array providing a composite three-dimensional presented image formed by a plurality of image segments provided by the presentation surfaces of the modules in the array.

In some example embodiments, the first panel and the second panels may be arranged to form a representation of a closed structure.

In some example embodiments, the presentation surfaces may each be substantially parallel to one of the first and second reference planes.

In some example embodiments, the first reference plane may be horizontal and the second reference plane is vertical.

In some example embodiments, at least one of the panels may include a layer with the image segment applied thereto.

In some example embodiments, at least one of the panels may include an LED screen configured to present a corresponding image segment.

In some example embodiments, the first and second panels may form a portion of a cube.

In some example embodiments, the cube may be formed by at least one first panel and at least three second panels.

In some example embodiments, each second panel may include a second peripheral region, and the first peripheral region may be joined with each of the second peripheral regions.

In some example embodiments, the second peripheral region of each second panel may be joined with the second peripheral region of at least two other neighboring second panels.

In another aspect, there is provided an array according to any one or more clause, example, claim, or part thereof, in the present disclosure or claims.

In some example embodiments, the modules may be tessellated to form the array.

In some example embodiments, the tessellated modules may be configured to provide tessellated surfaces in at least two different planes associated with the first reference plane.

In another aspect, there is provided a luminaire module comprising a support structure configured to be positioned so as to be associated with an interior space surface. The support structure may include or support a plurality of panels, wherein each of the panels may be configured to be inclined at an angle of less than 90 degrees from a corresponding reference plane, and in adjacent relation with at least one other of the plurality of panels along respective adjacent peripheral regions. One or more of the panels may be operative to provide an illuminatable presentation surface. The luminaire module may be configured to be assembled in an array thereof with the one or more presentation surfaces in the array providing a composite three-dimensional presented image formed by a plurality of image segments provided operative ones of the one or more presentation surfaces of the modules in the array.

The present disclosure may be implemented advantageously on an electronic device within a computing and communications environment that may be used for implementing the devices, structures, modules and/or methods disclosed herein.

The electronic device typically comprises a processor, which may be and/or function as the processor of the controller, and a memory, which may be and/or function as the memory of the controller. In some cases, the electronic device may further comprise any one or more of a bus to connect components of the electronic device, a network interface, a mass storage device, a video adapter and/or an input and/or output (I/O) interface.

The electronic device may utilize all, or only a subset of such components, and levels of integration may vary from device to device.

The electronic device may comprise multiple instances of such components, such as, by way of non-limiting example, multiple processors, memories, transmitters and/or receivers.

The processor may be one or more central processing units (CPUs), including without limitation, either or both of general and specific microprocessors, and may further include specialized processors such as a graphics processing unit (GPU), digital signal processor (DSP), or other such processor, including without limitation, dedicated hardware circuits for performing a specific functionality.

The processor may provide functions by executing instructions, codes, computer programs and/or scripts, which it accesses from the memory and/or a mass storage device in the form of software and/or firmware and/or in any combination of hardware, software and/or firmware. The functions may be provided by a single dedicated processor, by a single shared processor, or by a plurality of individual processors, some of which may be shared or distributed.

The functions provided, including without limitation, functional blocks labelled in the drawings and described herein as “functions”, “blocks”, “modules”, “processors” and/or “controllers”, may be provided through the use of dedicated hardware, as well as hardware capable of executing software, but should not be understood to refer exclusively to such hardware.

Such instructions, codes, computer programs and/or scripts may be implemented in a high-level procedural or object-oriented programming language, a markup language, in source, object and/or assembly code and/or machine language. Such code or language may be compiled or interpreted. In particular, the foregoing description of one or more specific examples does not limit the present disclosure to any particular computer programming language, operating system, system architecture or device architecture.

While the instructions may be discussed in the present disclosure as being executed by a processor, in some examples, the instructions may be executed serially, simultaneously or in parallel.

The memory may comprise any type of non-transitory volatile and/or non-volatile system memory, readable by the processor, such as, without limitation, random access memory (RAM), used to store volatile data and perhaps to store instructions, including without limitation, static RAM (SRAM), dynamic RAM (DRAM), synchronous DRAM (SDRAM), read-only memory (ROM), a non-volatile memory device (which typically has a small memory capacity relative to the memory capacity of mass storage devices), such as, without limitation, programmable ROM (PROM), erasable PROM (EPROM), electrically erasable PROM (EEPROM), flash memory devices, or any combination thereof. Access to either both of RAM and/or ROM is typically faster than to mass storage devices. In some examples, the memory may be implemented as and/or comprise one or more buffer circuits, such as, without limitation, a latch or a flip flop. In some examples, the memory can be supplemented by, or incorporated in, any one or more of an application-specific integrated circuit (ASIC), field-programmable gate array (FPGA) and/or DSP.

The processor may receive instructions and/or data from RAM and/or ROM.

The memory may include more than one type of memory, such as, by way of non-limiting example, ROM for use at boot-up and DRAM for program and/or data storage for use while executing instructions. In some example embodiments, the memory may serve as a cache or interim storage medium for storing data that otherwise would be stored in and accessed from the mass storage device.

The memory may be accessed directly by the processor, or indirectly along a bus, a network interface and/or an I/O interface.

The bus may be any one or more of any type of several bus architecture, including without limitation, a processor bus, a memory bus or memory controller, a peripheral bus, a video bus, a hard drive controller, and/or an I/O controller.

The network interface may be a wired network interface to connect to a network, a wireless network interface, including, without limitation, a radio access network interface for connecting to other devices over a radio link. In some examples, the network interface may take the form of a network connectivity device, such as a modulator-demodulator (modem), a modem bank, a network card, such as, without limitation, a local area network (LAN) card, such as an ethernet card or a token ring card, a wireless LAN (WLAN) card, a radio transceiver card, such as, without limitation, a code division multiple access (CDMA) or global system for mobile communications (GSM), third generation (3G), including without limitation, general packet radio service (GPRS), universal mobile telecommunications system (UMTS), enhanced data rates for GSM evolution (EDGE), CDMA2000, wideband CDMA (W-CDMA), fourth generation (4G), including without limitation, long term evolution (LTE), WiMAX, fifth generation (5G) and/or later wireless technology card, a fiber distributed data interface (FDDI) card, a wireless local area a universal serial bus (USB) interface card, and/or some other serial interface card, a wireless interface and/or card, including without limitation, WiFi, Bluetooth, near field communications (NFC) and/or another well-known network device or interface.

The network interface allows the electronic device to communicate with a remote entity, such as a network such as, without limitation, an Internet or one or more intranets and/or a remote entity connected to such a network, by which the processor might receive information therefrom and/or output information thereto.

The network interface may comprise one or more transmitter and/or receiver for wireless or otherwise transmitting and/or receiving signals respectively.

The network interface may be accessed directly by the processor, or indirectly along a bus and/or another network interface and/or an I/O device.

The measurement station and the drive structure may be coupled to the electronic device by at least one of the bus, network interface and/or the I/O interface.

The mass storage device may comprise any type of non-transitory storage device, such as, without limitation, an internal or removable drive, such as, without limitation, a magnetic tape drive, a magnetic card or disk drive, a hard disk drive, an optical disk drive, including without limitation, a video disk drive, a CD-ROM disk and/or DVD-ROM disk, a magneto-optical disk drive and/or a solid state drive.

The mass storage device may be configured to store instructions, data and/or other information, and to make such instructions, data and/or other information accessible to the processor. In some example embodiments, the mass storage device may be integrated with a heterogeneous memory.

The mass storage device may be accessed directly by the processor, or indirectly along a bus, a network interface and/or an I/O interface.

The mass storage device may generally perform storage tasks compatible with higher latency but may provide lesser or no volatility. In some examples, the mass storage device may be used as an overflow storage device if the memory is not large enough to hold all working data.

The video adapter and/or I/O interface provide an interface to couple the electronic device to an internal and/or external I/O device. By way of non-limiting example, an I/O device may comprise a display coupled to the video adapter and/or a printer, a video monitor, liquid crystal display (LCD), light-emitting diode (LED) display, a touch screen display, a keyboard, keypad, switch, dial mouse, trackball, trackpad, speaker, headset, headphone, voice recognizer, card reader, paper tape reader, fingerprint, iris and/or facial scanning device, and other well-known I/O devices coupled to the I/O interface.

The I/O device may be accessed directly by the processor, or indirectly along a bus, a network interface and/or an I/O interface.

The electronic device may be an element of communications network infrastructure.

The electronic device may be a device that connects to the network infrastructure over a radio interface, such as a mobile telephone, smartphone, personal digital assistant (PDA) or other handheld device, personal computer (PC), audio-visual (AV) terminal, television, video monitor and other devices that may be classified as a user equipment (UE).

The electronic device may be a machine type communications (MTC) device (also referred to as a machine-to-machine (M2M) device), or another such device that may be categorized as a UE despite not providing a direct service to a user.

The electronic device may also be referred to as a mobile device, a term intended to reflect devices that connect to a mobile network, regardless of whether the device itself is designed for, or capable of, mobility.

When the electronic device is a network infrastructure element, the radio access network interface may be omitted for nodes or functions acting as elements of the PLMN, other than those at the radio edge of a network.

When the electronic device is infrastructure at the radio edge of the network, both wired and/or wireless network interfaces may be provided.

When the electronic device is a wirelessly-connected device, the radio access network interface may be present and may be supplemented by other wireless interfaces, such as, without limitation, Wi-Fi, Bluetooth and/or NFC network interfaces.

The electronic device may be a stand-alone device, while in other example embodiments, the electronic device may be resident within a data center. As will be understood by those having ordinary skill in the art, a data centre is a collection of computing resources (typically in the form of services) that can be used as a collective computing and/or storage resource. Within a data centre, a plurality of services can be connected together to provide a computing resource pool upon which virtualized entities can be instantiated. Data centers can be coupled together to form networks consisting of pooled computing and/or storage resources coupled to one or another by connectivity resources.

The connectivity resources may take the form of physical connections such as Ethernet and/or optical communications links, and in some instances, may include wireless communication channels as well. If two different data centers are coupled by a plurality of different communication channels, the links can be combined tougher using any of a number of techniques, including without limitation, the formation of link aggregation groups (LAGs).

It should be understood that any or all of the computing, storage and/or connectivity resources (along with other resources within the network) may be divided among different sub-networks.

Thus, the electronic device may be a programmable processing system suitable for implementing or performing one or more of the apparatus(es) or method(s) of the present disclosure. Those having ordinary skill in the relevant art will appreciate that it is understood that typically, the electronic device will have sufficient processing power, memory and/or mass storage resources and/or network throughput capability to adequately handle the workload imposed upon it by such apparatus(es) and/or method(s).

The apparatus(es) of the present disclosure may be implemented in a computer program product tangibly embodied in a machine-readable storage device, including without limitation, the memory and/or mass storage device, for execution by the processor and the method(s) and/or action(s) of the present disclosure can be performed by the processor executing one or more instructions, whether or not in a program thereof, to perform functions of the disclosure, by operating on input data and/or generating output data.

Information comprising the instructions and/or data to be acted upon by the processor, may be received and/or outputted by the processor in the form of a computer data baseband signal and/or a signal embodied in a carrier wave. The information may be exchanged between the electronic device and a network.

The signal may propagate in or on the surface of an electrical conductor, in a coaxial cable, in a waveguide, in an optical medium, including without limitation, an optical fiber, or in the air or free space. The information contained in the signal may be ordered according to different sequences, as may be desirable for either processing and/or generating the information, and/or in transmitting and/or receiving the information. The signal, whether baseband or embedded in a carrier wave, or other types of signals currently used or hereafter developed, and referred to herein as the transmission medium, may be generated according to several well-known methods.

Thus, an article of manufacture for use with an apparatus of the present disclosure, such as a pre-recorded storage device or other computer-readable medium, including program instructions recorded thereon, or a computer data signal carrying computer-readable program instructions may direct an apparatus of the present disclosure to facilitate the practice of a method of the present disclosure. It is understood that such apparatus(es), articles of manufacture and/or computer data signals also come within the scope of the present disclosure.

### BRIEF DESCRIPTION OF THE FIGURES

Several exemplary embodiments of the present disclosure will be provided, by way of examples only, with reference to the appended drawings, wherein:

FIG. 1 is a bottom perspective view of an array of luminaire modules in a ceiling region of an interior space, representing a firmament of a sunburst with a number of clouds;

FIG. 2 is a bottom plan view of the array of FIG. 1;

FIG. 3 is a front elevational view of the array of FIG. 1;

FIG. 4 is a left hand side elevational view of the array of FIG. 1;

FIG. 5 is a rear elevational view of the array of FIG. 1;

FIG. 6 is a right hand side elevational view of the array of FIG. 1;

FIG. 7 is a lower perspective view of a single luminaire module of the array of FIG. 1;

FIG. 8 is a bottom plan view of the module of FIG. 7;

FIG. 9 is a front elevational view of the module of FIG. 7;

FIG. 10 is a right hand side elevational view of the module of FIG. 7;

FIG. 11 is a rear elevational view of the module of FIG. 7;

FIG. 12 is a left hand side elevational view of the module of FIG. 7;

FIG. 13 is a bottom plan view of another array of modules 1, showing a representative tree trunk, branches, and a forest canopy from below;

FIG. 14 is a bottom perspective view of another array of luminaire modules in a ceiling region of an interior space, including an illuminated portion represented in an illuminated state;

FIG. 15 is a bottom plan view of the array of FIG. 14;

FIG. 16 is a front elevational view of the array of FIG. 14;

FIG. 17 is a left hand side elevational view of the array of FIG. 14;

FIG. 18 is a rear elevational view of the array of FIG. 14;

FIG. 19 is a right hand side elevational view of the array of FIG. 14;

FIG. 20 is a lower perspective view of a single luminaire module of the array of FIG. 14, including illuminated portions represented in an illuminated state;

FIG. 21 is a bottom plan view of the module of FIG. 14;

FIG. 22 is a front elevational view of the module of FIG. 14;

FIG. 23 is a right hand side elevational view of the module of FIG. 14;

FIG. 24 is a rear elevational view of the module of FIG. 14; and

FIG. 25 is a left hand side elevational view of the module of FIG. 14.

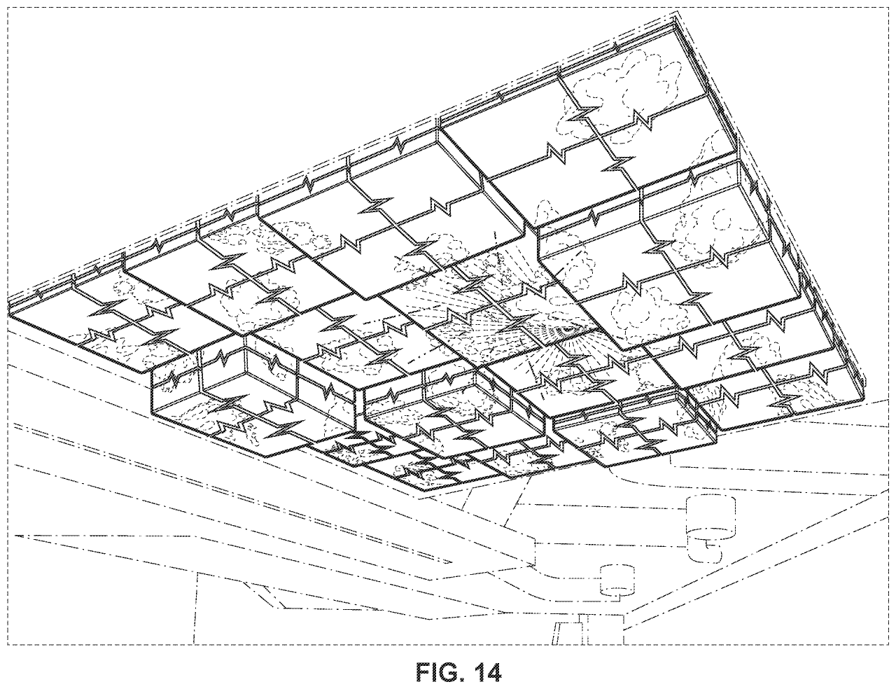

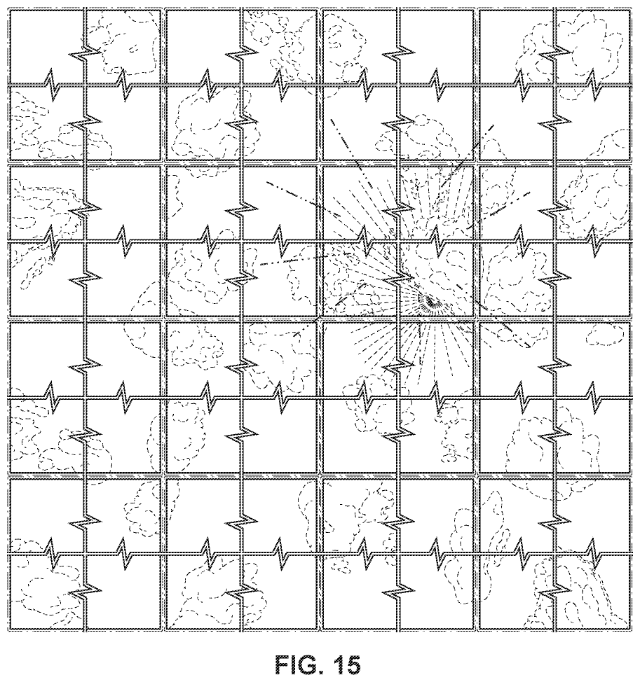

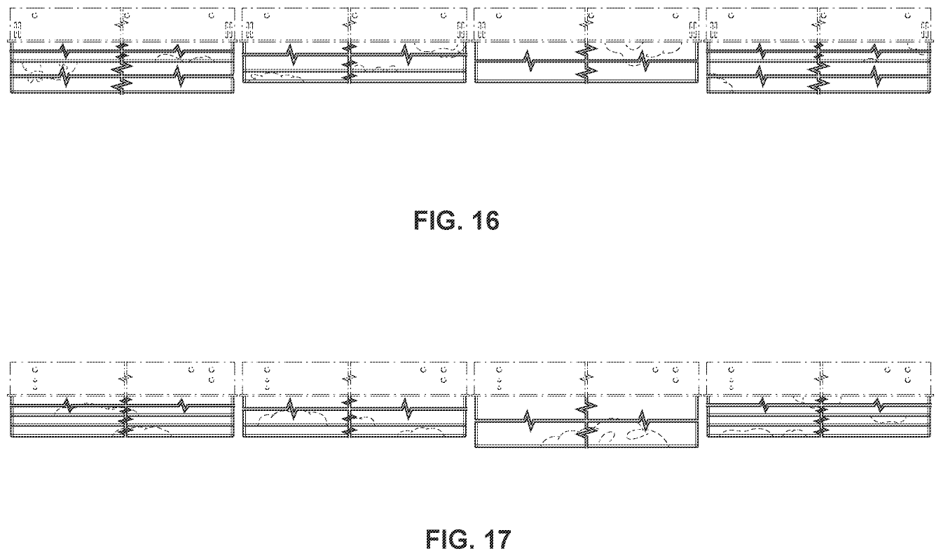

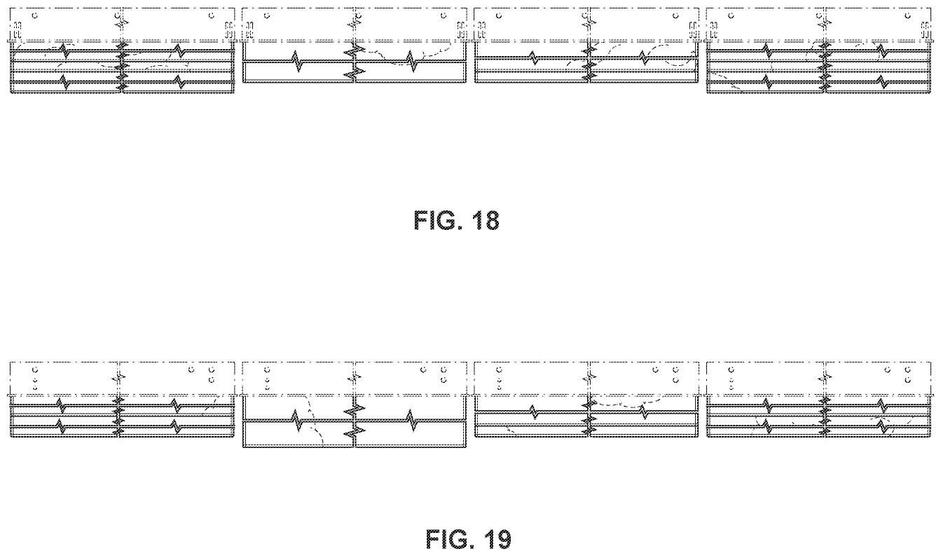

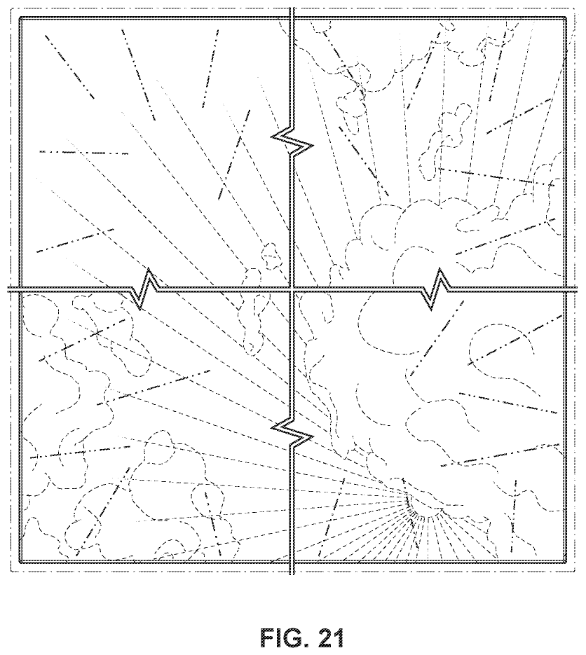

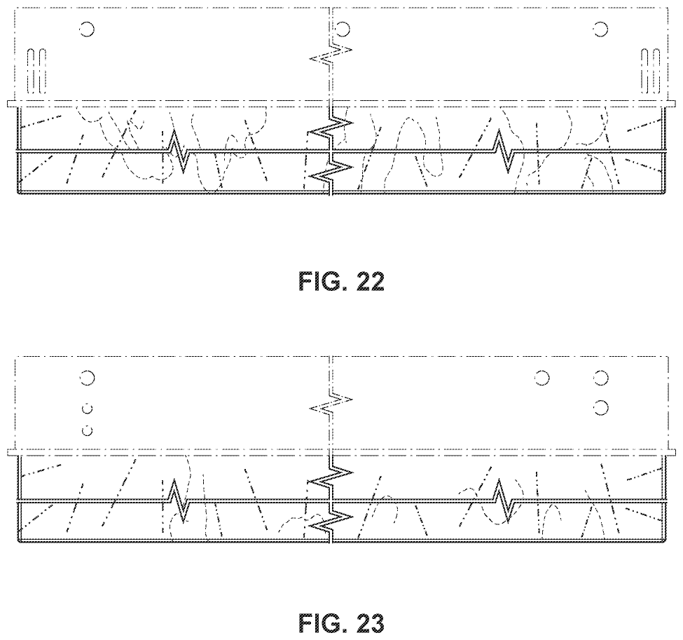

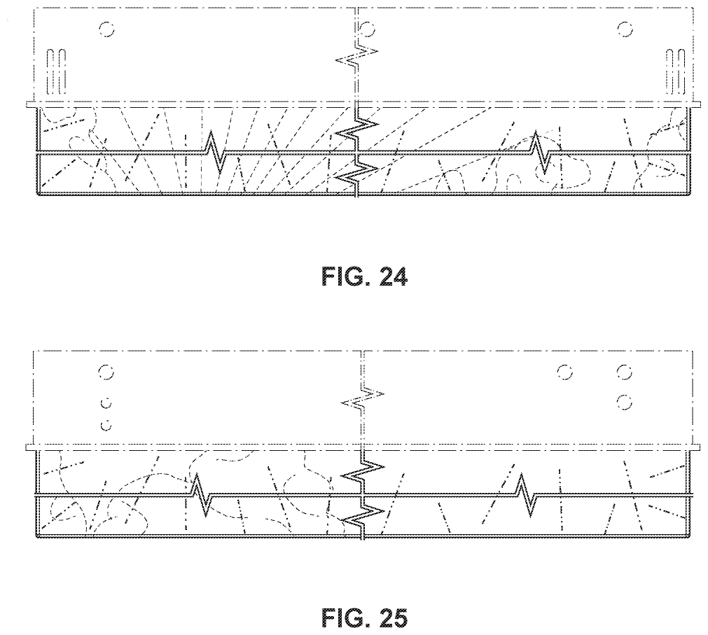

FIGS. 14 to 25 show modules alone or in arrays thereof, as examples of luminaire structures shown with symbolic break lines along some of its dimensions. The appearance of any portion of the article between the break lines forms no part of the design. Separations and brackets indicate that, for ease of illustration, the specific dimension of the article associated with the separation and corresponding brackets is not claimed and is to be broadly interpreted. The subject matter herein includes any of the present figures, or new figures based on the present figures, with one or more or less such broken lines shown in solid lines and vice versa. Thus, any change of such one or more broken lines to one or more solid lines, and vice versa, is not new matter.

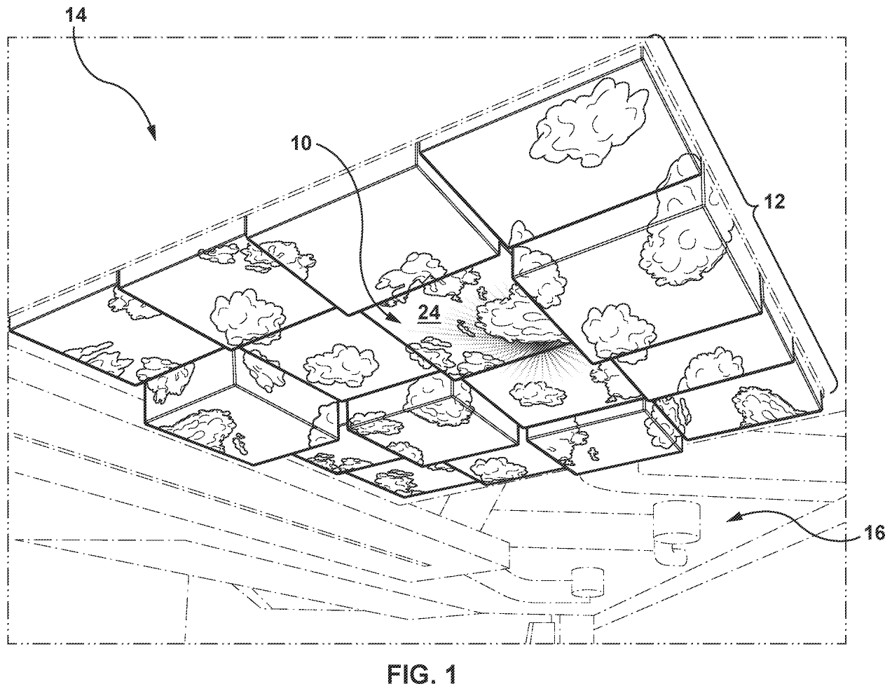

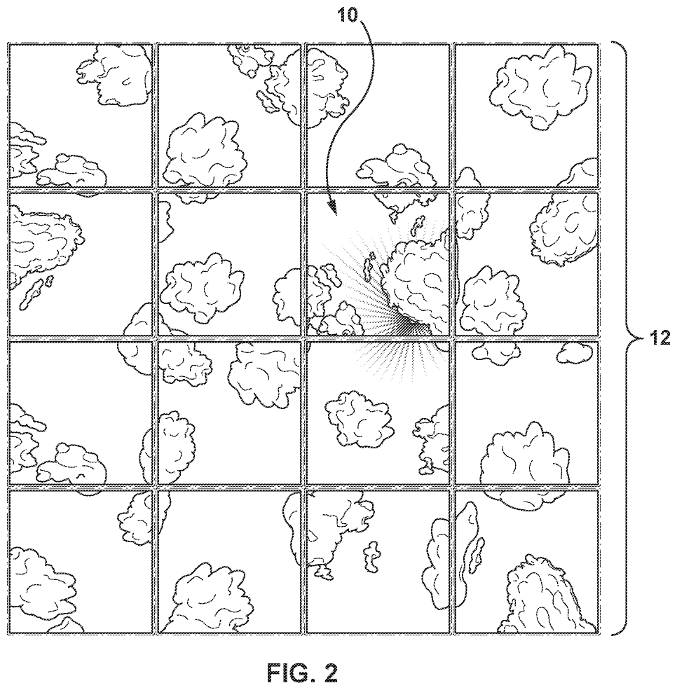

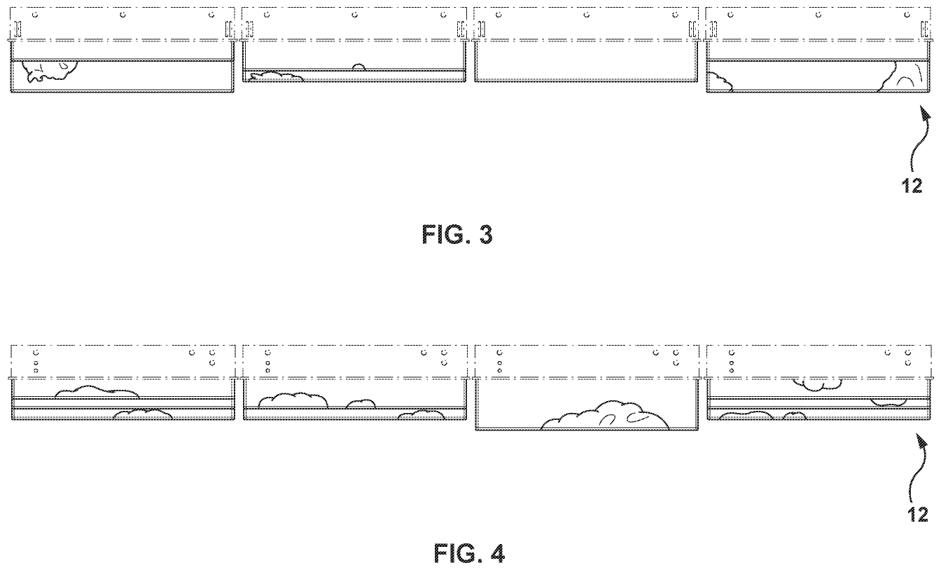

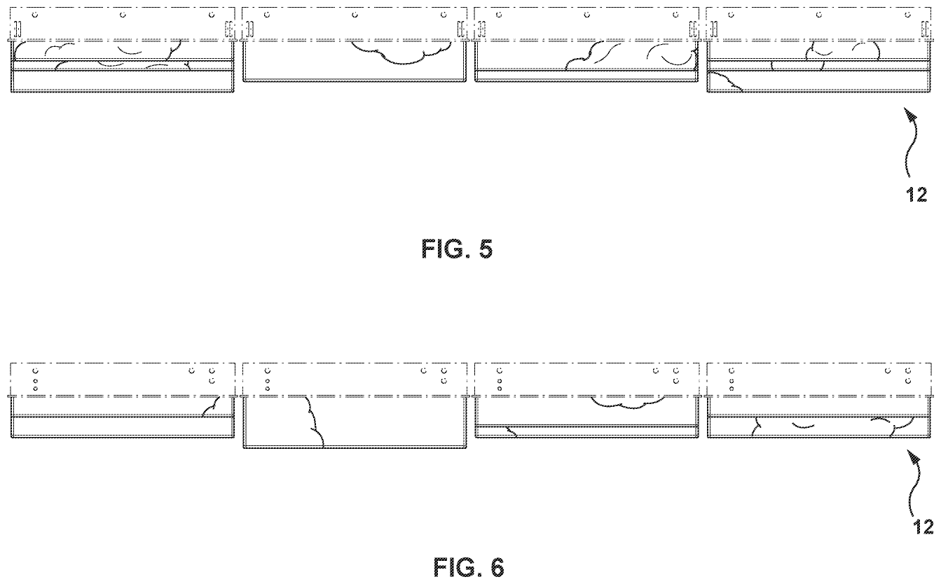

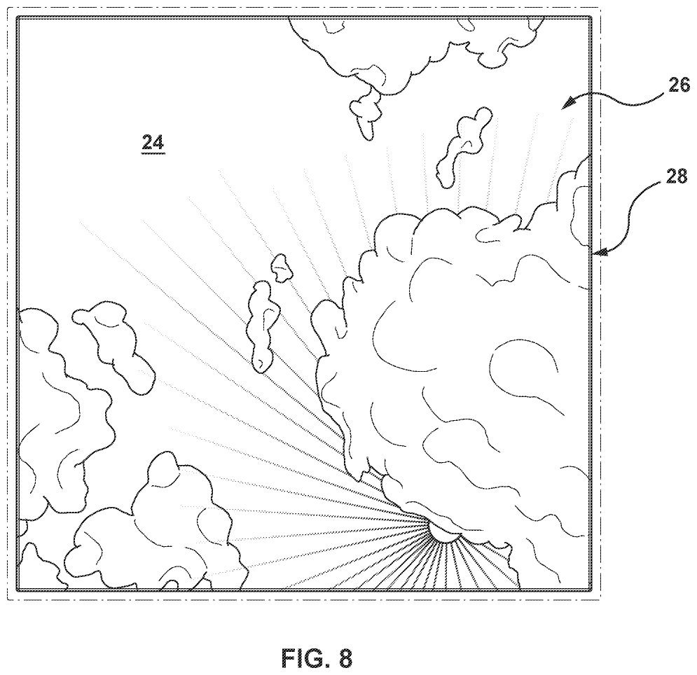

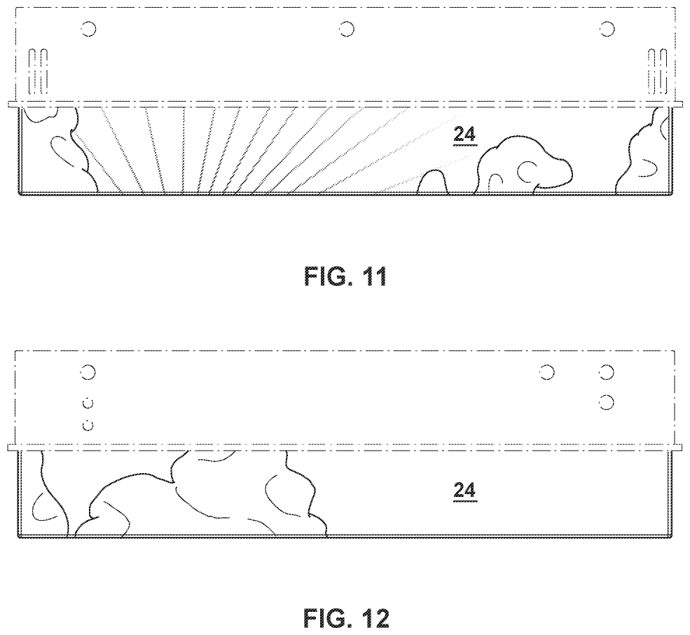

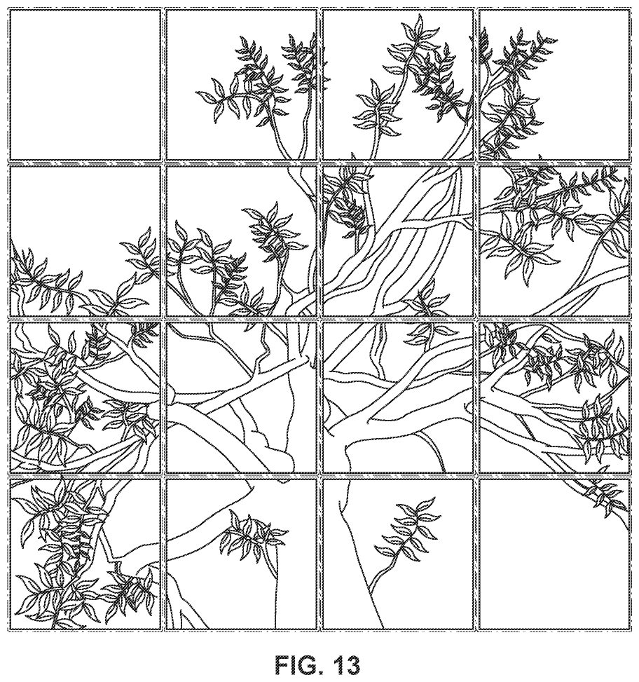

FIGS. 14, 15 and 20 to 25 show modules alone or in arrays thereof, as examples of articles exemplified as luminaire structures shown as having illuminatable portions capable of multiple states of illumination. The radiating line illumination representations shown in the embodiments of FIGS. 14, 15 and 20 to 25 are provided for the purpose of illustrating illumination portions in a state of illumination and are not intended to depict any particular color, texture, reflectivity, or material. Light providing the illumination in an illuminated state is not indicated to be nor intended to be emanating from any particular source or type of lighting device. Further, the radiating line illumination representations may also apply to any one or more or less surfaces in the embodiment of FIGS. 14, 15 and 20 to 25 which may or may not be presently shown or illustrated, as well as to any one or more surfaces in the embodiments of FIGS. 1 to 24, and 17 to 19 which may not be presently shown or illustrated. The article is not limited to the embodiments shown herein with the broken line radiating illumination representations. Rather, embodiments of the article in the present disclosure also encompass illustrated embodiments without the radiating line illumination representations on any one or more of the surfaces presently shown therewith. Thus, any removal or addition of such radiating line illumination representations is not new matter.

The articles are not limited to the scale shown herein. The claimed subject matter depicted in the drawings is not limited by the description given of the embodiment.

We claim, the ornamental design for a luminaire structure, as shown and described subject to amendment prior to allowance.

### DETAILED DESCRIPTION

It should be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical, mechanical or other connections or couplings. The terms upper, lower, and vertical are intended for operative context only and are not necessarily intended to limit the invention only to those configurations or orientations. Furthermore, and as described in subsequent paragraphs, the specific mechanical and/or other configurations illustrated in the drawings are intended to exemplify embodiments of the invention. However, other alternative mechanical and/or other configurations are possible which are considered to be within the teachings of the instant disclosure.

The term “LED” used herein may include, but not be limited to, semiconductor, electroluminescent, organic, polymeric or other material based light sources commonly known as generally as light emitting diodes, as well as polymeric and other such light sources, equivalents and variants thereof.

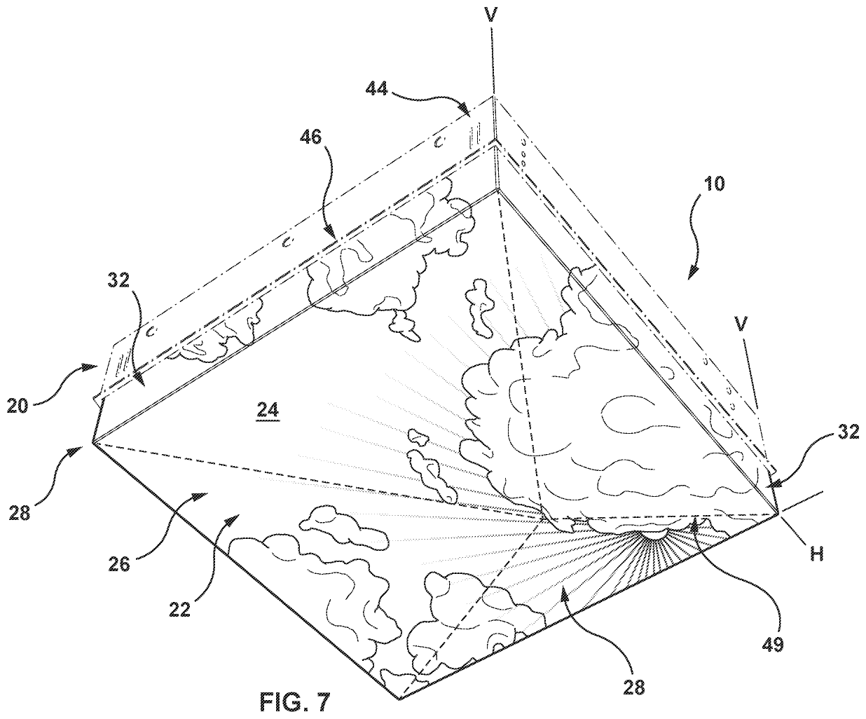

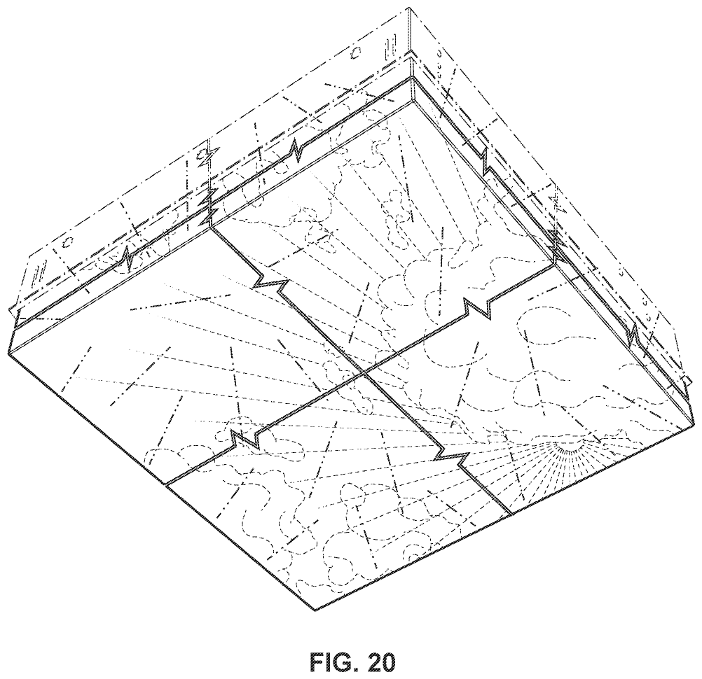

Referring to FIGS. 7 to 12, there is provided a luminaire module 10, which may be used singly or in an array of modules 12 located on a ceiling region 14 of an interior space 16, such as in FIGS. 1 to 6. Another luminaire module is shown in FIGS. 20 to 25, which may be used singly or in an array of modules, such as in FIGS. 14 to 19. As can be seen in FIG. 7, the luminaire module 10 comprises a support structure 20 configured to be positioned so as to be associated with the ceiling region 14 of the interior space 16, as shown for example in the array 10 of FIG. 1.

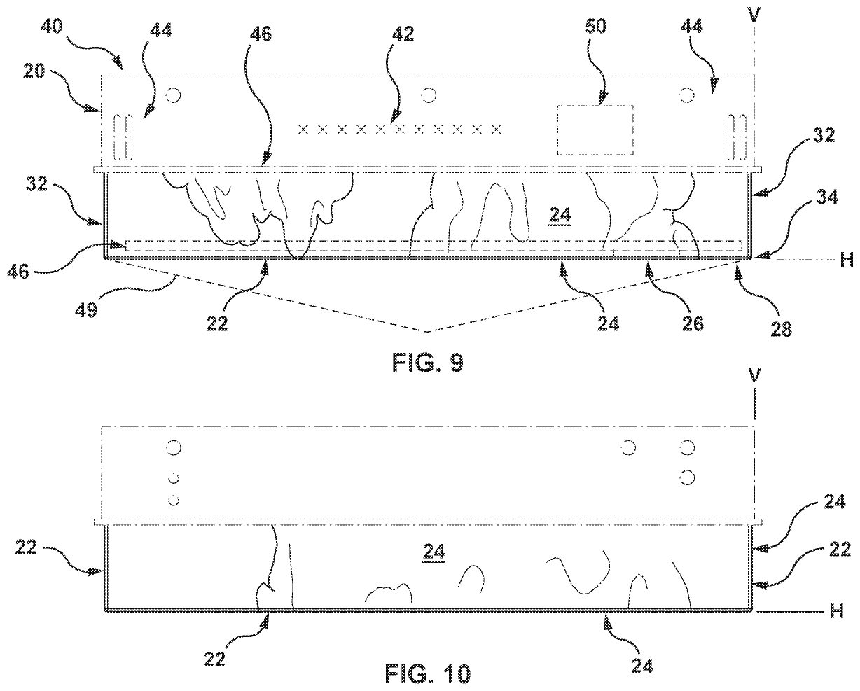

Referring to FIGS. 9 and 10, the support structure 20 may include and/or support a plurality of panels 22 with at least one, or each thereof, defining a presentation surface 24. As shown in FIGS. 14, 15, and 20-25 the presentation surface may be illuminatable. The plurality of panels 22 may include at least one first panel 26 with a first peripheral region 28. In this case, the first panel 26 is configured to be inclined at an angle of less than 90 degrees from a first reference plane, such as horizontal H, and a plurality of second panels 32, each of which being oriented to be upright at an angle of less than 90 degrees from a second reference plane, such as vertical V, in which the second panels 32 are in side by side relation along the first peripheral region 28.

The luminaire module 10 may be configured to be assembled in the array 12, as shown for example in FIG. 1, with one or more of the presentation surfaces 24 of one or more of the panels 22 in the array 12 configured to provide a composite image in three dimensions formed by image segments provided by the presentation surfaces 24 of the modules 10 in the array 12. In some example embodiments, designated ones of the second panels 32, and not necessarily all thereof, may be provided with an illuminatable presentation surface 24.

While a luminaire module 10 has been shown in a generally rectilinear configuration in three dimensions, it is anticipated that other geometric configurations in three dimensions may be used for this luminaire module. As an example, modules having a first panel 26 lying in the first-reference plane H may have a triangular, pentagonal, hexagonal or any other number of regular and irregular geometric configurations, as well as circular or other curved configurations. In this regard, such a configuration would also include one or more sets of second panels 32 oriented in the second reference plane V. Further configurations may include those shown in co-pending U.S. Design application 29/652,788, filed Nov. 30, 2020, which may have a peripheral three dimensional peripheral regions with an annular first panel and an additional recessed first panel, with inner and outer set of outer second panels. While these might create arrays 12 having different appearances than those as shown in the present figures, this would provide additional design alternatives and aesthetics. In addition, an array 12 could be configured with any number of different geometric configurations from those as mentioned above as well as others. This would further expand the design alternatives and aesthetic.

Referring to FIG. 9, the support structure 20 may include a housing 40 to support or contain a light source, such as an LED array as shown schematically at 42. The housing 40 may further include mounting structure as shown by one or more holes or support webs, as can be seen schematically at 44, at respective ends of the housing 40, as well as external positioning structure for positing the luminaire module 10 in the array 12, such as shown, for example, by a series of outwardly extending flanges 46, to engage a t-bar or other grid ceiling network.

In some example embodiments, as shown in FIGS. 9 and 10, the first panel 26 and the second panels 32 may be arranged to form a representation of a closed structure. In some example embodiments, the presentation surfaces 24 may each substantially parallel to one of the first and second reference planes, or other configurations of relative angles.

While the first reference plane H is horizontal and the second reference plane is vertical for the luminaire module 10, the first and second reference planes may respectively be vertical and horizontal.

Referring to FIG. 9, at least one of the panels 22 may includes a layer with the image segment applied thereto. In some example embodiments, at least one of the panels 22 may include and/or support a screen 46 configured to present the image segment, such as one or more computer screens, or other presentation devices with LED, LCD or other image presentation arrays. In this case, the at least one of the panels 22 may receive display instructions from a computer processor, shown schematically at 50, either integral to the least one of the panels, or separate therefrom, and located with the module or remote therefrom. In the latter case the computer processor 50 may be configured to coordinate, either directly or indirectly through other computer processors, the images appearing on more than one such panels 22, as need be to present a composite three-dimensional (“3D”) image to the viewer beneath the array 12.

As can be seen in FIGS. 7 to 10, the first and second panels 26, 32 may form a portion of a cube. In some example embodiments, the cube may be formed by at least one first panel and at least three second panels. Alternatively, in at least some instances, the first and second panels may be angled in relation to one or more reference planes so as to form a plurality of panels which cooperate to form a pyramidal or other angled configuration 49, such as shown schematically at 48 in FIGS. 7 and 9. In addition to other angled configurations, curved configurations could be used providing generally consistent convex, concave, or a mixture of different concave and convex surfaces formed into the panel 22 generally oriented in the first reference plane. Similarly, the second panels 32 can be provided with additional surface configurations both angular as well as curved as described above. The addition of different surface configurations for the panels in the various reference planes can expand the design options as well as aesthetic of the overall luminaire module 10, as well as the configured array 12.

In some example embodiments, each second panel 32 may be provided with a second peripheral region, and wherein the first peripheral region 26 is joined with each of the second peripheral regions 34.

In some example embodiments, the second peripheral region 34 of each respective second panel 32 may be joined with the second peripheral region of at least two other neighboring second panels.

As can be seen in FIG. 1, the modules 10 may be provided in a number of configurations, such as a tessellated configuration, to form the array 12. The tessellated modules may be configured to provide tessellated surfaces in at least two different planes associated with the first reference plane 14. The multiplicity of the surfaces in the at least two different planes may enable the presentation of a composite 3D image in a way that is recognized as such by the eye of the viewer below the array 12, without requiring a more accurate 3D shape to the collection of surfaces presenting the image. In the example of the sunburst and cloud configuration in FIG. 1, and the tree trunk and canopy of FIG. 15, or other presentation, the collection of surfaces may be configured to provide the viewer sufficient information in three dimensions to provide a comparable experience to a surface providing individual 3D substructures in the surface to represent the sun and the clouds. Thus, a combination of surfaces which themselves may not provide any localized 3D-shaped structural elements to contribute an individual element of the collective image, may nonetheless provide an overall 3D representation in a configuration of surfaces in at least two planes, where the surfaces may themselves be planar, curvilinear, angled, or any combination thereof.

While the present disclosure describes various exemplary embodiments, the disclosure is not so limited. To the contrary, the disclosure is intended to cover various modifications and equivalent arrangements, as will be readily appreciated by the person of ordinary skill in the art.

1. A luminaire module comprising a support structure configured to be positioned so as to be associated with a ceiling region of an interior space, the support structure including or supporting a plurality of panels with each thereof defining a illuminatable presentation surface, the plurality including at least one first panel including a first peripheral region, the first panel configured to be inclined at a first angle of less than 90 degrees from a first reference plane, and a plurality of second panels, each of which being oriented to be upright at a second angle of less than 90 degrees from a second reference plane, in which the second panels are in side by side relation along the first peripheral region, wherein the luminaire module is configured to be assembled in an array thereof with the presentation surfaces in the array providing a composite three-dimensional presented image formed by a plurality of image segments provided by the presentation surfaces of the modules in the array.

2. The luminaire module according to claim 1, wherein the first panel and the second panels are arranged to form a representation of a closed structure.

3. The luminaire module according to claim 1, wherein the presentation surfaces are each substantially parallel to one of the first and second reference planes.

4. The luminaire module according to claim 1, wherein the first reference plane is horizontal and the second reference plane is vertical.

5. The luminaire module according to claim 1, wherein at least one of the panels includes a layer with the image segment applied thereto.

6. The luminaire module according to claim 1, wherein at least one of the panels includes an LED screen configured to present a corresponding image segment.

7. The luminaire module according to claim 1, wherein the first and second panels form a portion of a cube.

8. The luminaire module according to claim 7, wherein the cube is formed by at least one first panel and at least three second panels.

9. The luminaire module according to claim 1, wherein each second panel includes a second peripheral region, and the first peripheral region is joined with each of the second peripheral regions.

10. The luminaire module according to claim 9, wherein the second peripheral region of each second panel is joined with the second peripheral region of at least two other neighboring second panels.

11. The array according to claim 1.

12. The array according to claim 11 wherein the modules are tessellated to form the array.

13. The array according to claim 12, wherein the tessellated modules are configured to provide tessellated surfaces in at least two different planes associated with the first reference plane.

14. A luminaire module comprising a support structure configured to be positioned so as to be associated with an interior space surface, the support structure including or supporting a plurality of panels, each of the panels configured to be inclined at an angle of less than 90 degrees from a corresponding reference plane, and in adjacent relation with at least one other of the plurality of panels along respective adjacent peripheral regions, wherein one or more of the panels is operative to provide an illuminatable presentation surface, wherein the luminaire module is configured to be assembled in an array thereof with the one or more presentation surfaces in the array providing a composite three-dimensional presented image formed by a plurality of image segments provided operative ones of the one or more presentation surfaces of the modules in the array.
